(19) United States
(12) Patent Application Publication
(10) Pub. No.: US 2019/0389010 A1
(43) Pub. Date: Dec. 26, 2019

(54) Laser processing method for increasing hole diameter

(71) Applicant: Preco, Inc., Somerset, WI (US)

(72) Inventors: Kurt Hatella, New Richmond, WI (US); James J. Bucklew, Somerset, WI (US); Steven J. Roffers, Hudson, WI (US)

(21) Appl. No.: 16/448,996

(22) Filed: Jun. 21, 2019

Related U.S. Application Data
(60) Provisional application No. 62/689,603, filed on Jun. 25, 2018.

(51) Int. Cl. B23K 26/384; B23K 26/08; B23K 26/0622; B23K 26/40

(52) U.S. Cl. CPC B23K 26/384; B23K 26/40; B23K 26/0622; B23K 26/083

(57) ABSTRACT

A method for laser drilling holes on a moving web of material wherein the laser system can be used to drill holes having a diameter less than about 300 micron and holes having a diameter greater than about 300 micron without increasing the energy of the laser beam, and without laser profiling the hole to increase the diameter. The method comprises pulsing the laser beam a plurality of times while directing the focal point of the laser beam for each pulse on to the same target area on the material to produce a hole having an increased diameter.

### CROSS-REFERENCE TO RELATED APPLICATION

The present application is based on and claims the benefit of U.S. provisional patent application Serial No. 62/689,603, filed Jun. 25, 2018, the content of which is hereby incorporated by reference in its entirety.

### BACKGROUND

The present invention relates to a high speed laser drilling system, and more particularly to a method of operating a laser drilling system to achieve increased laser hole diameter without requiring increased laser beam power or energy density.

Laser systems are often employed to create a plurality of small holes distributed across a material. The material can be provided as a moving or advancing web, and such systems are advantageous because of the high product advancement speed and laser hole resolution that can be achieved. That is, the material can be quickly processed with patterns of small holes.

U.S. Pat. RE 44,886E1 discloses a method and apparatus for improving laser hole resolution on a moving web of material. A CO₂ laser is used to create a single pulse of laser energy. The laser energy is focused by a lens and reflected off of a rotating mirror that is synchronized with the motion of the material that is passing there under. However, the CO₂ laser and the synchronization with the moving web result in an upper limit on the size (e.g., diameter) of the hole that can be created with this laser beam and this method of processing a moving web.

In applications where a larger hole is desired, a second laser system, having the capability for more laser energy per pulse is generally required. This is an undesirable alternative due to the high cost of the laser system. Laser systems generally incorporate laser beams (e.g., wavelength, power etc.) that are configured for and capable of producing either small holes or large holes on an advancing web of material while maintaining commercially viable or cost efficient material processing speeds.

### SUMMARY

One aspect of the present disclosure relates to a method for increasing the diameter of a laser drilled hole in a material by pulsing a laser beam a plurality of times without increasing laser energy per laser pulse and without reducing laser beam quality and wherein a focal point of the subsequent laser beam pulse touches substantially a same target area with each pulse thereby increasing the diameter of the hole with each subsequent laser beam pulse.

The method for increasing the diameter of the laser drilled hole allows a laser system, such as a system using a CO₂ laser beam, to be utilized to produce holes of a first diameter and holes of a second, greater, diameter without changing the laser beam energy, laser beam quality or other laser beam power settings and without profiling the hole.

The method can be used to produce holes in a moving web having a diameter greater than about 300 micron or for example holes having a diameter in the range of about 300 micron to about 500 micron.

Another aspect of the present disclosure relates to providing a laser processing system having a laser source for generating a pulsed laser beam and a lens for focusing the pulsed laser beam and reflecting the pulsed laser beam onto the advancing web of material. Producing one or more holes in the web of material comprises setting a pulsing rate of the laser beam in coordination with a selected spacing of a laser hole pattern for the advancing web. A laser beam spot or focal point is directed to a first selected location, and the laser beam is pulsed for producing a first hole having a first diameter. Subsequently pulsing the laser beam one or more times in the first selected location and directly over the previous pulse(s) produces a hole having a second diameter, the second diameter of the hole being greater than the first diameter of the hole.

One, two, three, four, or more subsequent pulses may be used to increase the diameter of the hole to produce a hole having a predetermined subsequent enlarged diameter. The subsequent diameter may be in the range of about 300 micron to 400 micron, or greater than 400 micron. For example, the subsequent diameter may be about 500 micron. Moving the laser beam focal point in coordination with the moving web allows for directing the subsequent laser beam pulses on to the same location on the web as the hole is produced with the first pulse and also allows for producing a plurality of holes in the web. The plurality of holes may comprise holes of substantially the same diameter or holes of varying diameters.

### DETAILED DESCRIPTION

The methods described herein are carried out using a laser assembly and laser processing method referred to as laser drilling, to produce one or more holes in a substrate such as a moving web of material. What is meant by laser drilling for purposes of this disclosure and as discussed throughout this disclosure is the process of creating perforations or thru-holes, sometimes referred to as “popped” holes or “percussion drilled” holes, by pulsing focused laser energy on the material to vaporize or ablate the material. The diameter of these holes can be as small as about 50 micron. In the methods described herein, the diameter of the drilled hole is increased by using multiple laser pulses directed on top of each other. The pulses are each directed to a target area on the web and when directing the pulses on top of each other, the pulses are directed to the same target area. The target area of each of the pulses is synchronized to the movement of the moving web of material thereby producing a larger diameter hole than could otherwise be produced with a single pulse of the laser beam. This is in contrast to other methods of making larger holes with a laser beam which include directing or moving the laser beam around the circumference of the drilled hole until the desired diameter is created, a process referred to as profiling a hole.

The term diameter as used herein refers to the diameter of the hole at or near the surface or laser impinged surface of the material. Generally the smaller diameter hole referred to herein is a hole having a diameter in the range of about 85 micron to about 300 micron or less and the larger diameter hole referred to herein is a hole having a diameter greater than about 300 micron or greater than about 400 micron and as described in further detail below. However, the terms smaller (or small) and larger (or large) can be considered relative to one another with respect to this disclosure. The smaller diameter hole is the hole that would be produced by a laser system with a selected laser beam wavelength, energy, beam quality, spot size and/or combinations thereof with one pulse of the laser beam. That is, the smaller diameter hole is the hole the laser system is capable of producing with one pulse of the laser beam (e.g., a standard laser drilled hole). The larger diameter hole is then the hole that would be produced by the same laser system with the same selected laser beam wavelength, energy, beam quality, spot size and/or combinations thereof with a plurality of pulses of the laser beam on the same or substantially same target location on the material. That is, the larger diameter hole is the hole the laser system is capable of producing with two, three, four, five, or more laser pulses directed to the same target area to form a single hole.

Packaging materials including packaging for frozen food and microwaveable packaging may incorporate holes having a diameter on the scale of about 300 micron or greater, or about 400 micron or greater. The primary requirement for frozen food packaging is sufficient air evacuation in order to reduce the package size for shipment, and to reduce the “pillow effect” on the package as they are presented on store shelves. The holes provided in microwavable packaging act as vents which allow for a controlled steam release from within the packaging. With a CO₂ laser there are several methods to create so called larger diameter holes (diameter greater than about 300 micron), including defocusing the laser beam, modifying the laser beam to increase the M² (a dimensionless parameter for quantifying the beam quality of the laser beam), altering the laser beam diameter, profiling each individual hole, or increasing the focal length of the laser beam.

The materials processed according to the assemblies and methods described herein include but are not limited to any thin film material such as any printed or coated plastic or cellulose film, paper, metallized material or laminate, or aluminum foil material, and/or co-extruded plastic films for special applications. Suitable materials include, but are not limited to, plastic or polymeric materials such as polyethylene (PE), linear and low-density polyethylene (LLDPE and LDPE), polyethylene terephthalate (PET), oriented polypropylene (OPP), or other polymers. Similar polymers such as, for example, metallocene doped polyethylene are also within the scope of the present invention. Generally, the present invention may be used with either multi-layer homogenous or non-homogenous film materials or single-layer film materials of uniform composition. Generally, any type of flexible packaging material may be laser perforated or drilled as taught by the present disclosure. For purposes of this disclosure, the material, or moving web, may be any flexible packaging material of either multiple layers of different compositions or a single layer of uniform composition.

However, prior art methods for increasing the diameter of a laser produced hole in a material face challenges. For example, most lasers have a limited amount of energy that can be generated in a single pulse of the laser beam. Some lasers are optimized for pulsing, and therefore have a limited maximum pulse length and duty cycle. With limited laser energy, there is a corresponding limit to the amount of material that can be vaporized by the laser beam to produce a hole in the material. In contrast, the methods described herein utilize multiple laser pulses that are directed to the same or substantially the same target area on the web, such that pulses are directed substantially over each other and the pulses are synchronized to the movement of the web of material. The plurality of pulses thus produces a larger diameter hole than could otherwise be produced by that same laser system and settings using a single pulse.

The methods described herein address a problem associated with prior art laser drilling systems by providing a method for producing a hole having an increased diameter over the maximum diameter hole that the laser system could otherwise produce. The method described herein is a method for increasing the diameter of a hole produced in a moving web, without increasing the laser power or laser energy provided in a single pulse of the laser beam, and without reducing the beam quality. Thus, according to the methods described herein, the same laser system and beam settings such as wavelength, pulse length and duty cycle etc. can be used to produce both small and large diameter holes in a web of material.

In further detail, the methods described herein utilize a laser-generating source which provides a pulsed laser beam. What is meant by a pulsed laser beam is that the laser beam alternates between a “laser-on” time and a “laser-off” time, wherein vaporization of the material occurs during the laser-on time as the laser beam impinges on the surface of the material. The laser beam is reflected to direct a focal point of the laser beam onto the surface of the material to vaporize or ablate the surface to form the hole having a diameter corresponding in part to a spot size of the laser beam (e.g., focal point). The material may be provided as a moving web, such that material is moving, or advancing, through the laser assembly. The focal point of the laser beam can then also be moved in a direction of the material advancement path during the laser-on time and may be moved in a direction opposite to the direction of the product advancement path during the laser-off time to produce a plurality of holes in the moving web.

For example, as described in U.S. Pat. RE 44886E1, the contents of which are herein incorporated by reference in its entirety, a method of laser drilling a hole comprises moving a focused laser beam spot at a point where it impinges on an advancing web/product in the same direction as the web/product is moving. The “effective speed” of the web/product in relation to the focused laser beam spot is therefore reduced by the speed of the spot. As a result, higher laser hole resolution may be achieved for a particular absolute web/product advancement speed, since the effective speed of the web/product with respect to the spot is reduced. Several exemplary embodiments are described in U.S. Pat. RE 44886E1 and these systems may be used with the methods described herein. The holes produced with these methods and the assemblies described therein generally have a diameter in the range of about 85 micron to about 300 micron. Laser processing according to the methods described herein can increase the diameter of the hole produced to about 300 micron or greater, and for example in the range of about 300 micron to about 500 micron, or greater than about 500 micron while maintaining the margins of each hole.

When using a CO₂ laser beam and a laser assembly as described above, a single pulse of laser beam energy can produce a hole having a size ranging from about 85 micron to about 300 micron in diameter. The pulse duration or “laser-on” time required to make such a hole is in the range of about 20 μ seconds to about 300 μ seconds. Once a selected hole diameter is larger than 400 microns, the amount of laser energy required to make the hole becomes prohibitive using prior art laser drilling (e.g., use a pulsed and directed laser beam) and instead it becomes more time and cost effective to profile the hole (as in the prior art) with a two or three axis galvanometer scanner (using laser-on time to direct the laser beam along a path around the diameter of the hole in order to increase the diameter of the hole, e.g., “profiling” the hole).

When the laser beam energy is increased in a laser system in a process to produce larger diameter holes (e.g., holes having a diameter greater than about 400 micron), the laser beam should have a Gaussian beam energy profile/measure of beam quality/M² of close to 1. An M² of 1 is a theoretical “perfect” beam quality and higher numbers indicate a decreasing beam quality. Using a spot size (focal point) equation, the highest beam quality usually results in the smallest available spot size (focal point) for the particular wavelength of the laser beam. Given this, one method for increasing the diameter of the holes without laser profiling is to increase the M², which then lowers the beam quality and still limits the diameter of hole that can be produced by a laser drilling process to less than about 300 micron or to less than about 400 microns.

The methods described herein may be utilized with “top hat” laser beam shaping optics or a laser system utilizing such optics. These optics comprise diffractive optical elements used to transform the laser spot into a more uniform-intensity spot (e.g., a flat spot) that can be round, rectangular, square or other geometric shapes as impinged on the web. For example, when using a near-Gaussian beam, the laser beam produces the smallest focused spot available given the beam diameter, wavelength, and focal length. There also is a significant amount of energy in the very center of the beam. Such laser beams are preferable for making small diameter holes, however if a larger diameter hole is selected, the laser energy in the center of the laser beam is “wasted” because the center of the hole being drilled vaporizes first, and the outer edges of the hole then follow, or otherwise lag behind. A round beam shaper optic is used to redistribute a portion of the energy from the center of the laser beam more evenly across the diameter of the focused spot. This creates a higher M² which creates a larger focused spot, but more importantly, this beam vaporizes the material more evenly and efficiently so that less laser energy is wasted when drilling holes. Thus, the holes perforated or drilled according to the methods described herein may have a round, rectangular, square or other geometric shape as produced on the web and having the increased diameter.

For example, the method described herein may be carried out with a laser system such as a Rofin SCx series of laser having a maximum pulse length of about 400 μsec and a maximum duty cycle of either approximately 50% or 85%. With a typical thickness of material up to approximately 0.004″ (but not limited to), the upper threshold of hole diameter that could be produced with the Rofin SCx series laser is about 250 μm or about 300 μm using a prior art laser drilling method. By utilizing the method described herein, the laser will be pulsed a plurality of times for a given hole, and a hole diameter of about 300-500 μm will be achieved.

The web of material can be processed to produce holes of one or more diameters and wherein at least one or more of the holes has a larger diameter such as a diameter greater than about 300 micron or greater than about 400 micron. The method comprises providing a laser processing system having a laser source for generating a pulsed laser beam (e.g., a CO₂ laser beam) and a lens for focusing the pulsed laser beam and reflecting the pulsed laser beam onto the advancing web of material. The lens for reflecting the pulsed laser beam onto the advancing web of material may be a stationary lens or a rotating lens to effectuate linear movement of the pulsed laser beam on the web.

To produce one or more holes in the web of material, the difference between the speed of advancement of the web and the speed of movement of the focal point of the laser beam on the web is low, enabling a high resolution laser hole to be drilled while web advances at a relatively high speed. A pulsing rate of the laser beam is also coordinated with the selected spacing of a laser hole pattern to achieve the proper spacing between holes. The laser beam is then pulsed one or more times to produce a selected hole. The laser beam spot or focal point is directed to a first selected target area, the selected target area being the location on the web of a first hole. The laser beam is pulsed to produce a hole having a first diameter. The laser beam is subsequently pulsed one or more times, the subsequent pulse(s) having the same or substantially the same target area (thus being directed on top of the target area of the previous pulse(s)) to produce a hole having a second diameter, the second diameter being greater than the first diameter. One, two, three, four, or more subsequent pulses may be used to increase the diameter of the hole to produce a hole having a predetermined second diameter. The laser beam moves in coordination with the moving web in order to direct the subsequent laser pulses on to the same target area on the web as first target area that originally produced the first hole. That is, the pulses are directed on top of the same or substantially the same target area in contrast to near or around the area on the web of one another.

### ILLUSTRATIVE EXAMPLE

A Coherent GEM100 laser was used to prove the concept described herein. The CO₂ laser beam was pulsed up to five (5) times per hole produced for each sweep of the galvo mirror. For example, the GEM100 (100-W) laser was used to mimic a 200-W Rofin SCx laser split into two beams. A 400-μs pulse length limit and an 80% duty cycle limit were utilized for testing purposes. The lens was defocused to create a larger spot size. Four 358-μs pulses were directed to the same target area to form each hole and each hole produced had an average hole diameter of 457 μm.

The laser system may utilize focusing optics including 2.5″or 3.75″ focal length optics.

Although the present invention has been described with reference to preferred embodiments, workers skilled in the art will recognize that changes may be made in form and detail without departing from the spirit and scope of the invention.

What is claimed is:

1. A method comprising pulsing a laser beam a plurality of times without increasing laser energy per laser pulse and without reducing laser beam quality and wherein a focal point of the laser beam is directed to substantially a same target area on a substrate for each pulse thereby increasing the diameter of a hole in the substrate with each subsequent pulse.

2. The method of claim 1 and setting a laser spot size to a setting to produce a hole having a first diameter when pulsing the laser beam one time on the target area and pulsing the laser beam one or more additional times at substantially the same target area to increase the diameter of the hole to a second diameter greater than the first diameter.

3. The method of claim 1 and forming a plurality of laser created holes having the second diameter and wherein the substrate is a moving web.

4. The method of claim 1 wherein the laser is a CO₂ laser.

5. The method of claim 1 wherein the substrate is flexible packaging material.

6. The method of claim 1 wherein the substrate is a thin film having a single layer or a multi-layer construction.

7. The method of claim 1 and further comprising providing a laser processing system having a laser source for generating the laser beam and the laser processing system comprising a lens for focusing the laser beam and reflecting the pulsed laser beam onto the substrate.

8. A method of laser drilling a plurality of holes having one or more diameters in a moving web of material, the method comprising:
providing a laser processing system having a laser source for generating a laser beam and the laser processing system comprising a lens for focusing the laser beam and reflecting the pulsed laser beam onto the advancing web of material;
directing a focal point of the laser beam to a first selected location on the web;
pulsing the laser beam one time to deliver laser beam energy to the first selected location for producing a hole at the first selected location, the hole having a first diameter;
moving the focal point of the laser beam in coordination with the moving web of material so as to maintain alignment with the hole having a first diameter;
pulsing the laser beam at least a second time at the first selected location on the web for increasing the first diameter of the hole at the first selected location to a second diameter wherein the second diameter is greater than the first diameter.

9. The method of claim 8, and further comprising subsequently pulsing the laser beam on the first selected location of the first and second pulse and pulsing the laser beam at least one of a third, fourth or fifth time to produce a hole having a final diameter wherein the final diameter is greater than the first diameter.

10. The method of claim 8, wherein the second diameter is greater than about 300 micron.

11. The method of claim 8, wherein the second diameter is greater than about 400 micron.

12. The method of claim 8, wherein the second diameter is in the range of about 300 micron to about 500 micron.

13. The method of claim 8, wherein a pulsing rate of the laser beam is also coordinated with the selected spacing of a laser hole pattern to achieve the proper spacing between a plurality of holes having the second diameter.

14. The method of claim 8, wherein the laser is a CO₂ laser.

15. The method of claim 8 wherein the substrate is a thin film having a single layer or a multi-layer construction.
